(19) United States
(12) Patent Application Publication
(10) Pub. No.: US 2016/0337823 A1
(43) Pub. Date: Nov. 17, 2016

(54) METHOD AND SYSTEM FOR THE IMPLEMENTATION OF CELL PHONE TEXTING TO BE USED WITH ENTERING DATA FOR SOCIAL NETWORKS

(71) Applicant: myActions, LLC, Cincinnati, OH (US)

(72) Inventors: Craig S. Young, Cincinnati, OH (US); James D. Young, Cincinnati, OH (US)

(21) Appl. No.: 15/153,148

(22) Filed: May 12, 2016

Related U.S. Application Data
(60) Provisional application No. 62/160,051, filed on May 12, 2015.

(51) Int. Cl. H04W 4/12; H04L 12/58; H04W 8/22; H04M 1/725

(52) U.S. Cl. CPC H04W 4/12; H04M 1/72552; H04L 51/32; H04W 8/22

(57) ABSTRACT

A method and system for individuals to quickly and easily share behaviors, actions, photographs, videos, other data, and/or posts on, but not limited to, a social network without needing to be logged into, or even having an account on, the social network/website. The system uses, but is not limited to, existing texting technology as an easy way for the individual to send keywords and/or additional information. The texting system has the ability to bi-directionally collect and send data from/to the texting device (e.g., cell phone) and has a bi-directional communication scheme to transfer the data from the texting system to the appropriate social network/website. The texting device provides a unique ID such as, but not limited to, the phone number, which can optionally be linked to an account. The social network then processes the information, optionally stores the information, and/or responds. Feedback may be presented by the website texting back to the texting device, presenting the response on a separate display, displaying the information on the website, or by other means. The content of the feedback can, but is not limited to, encourage the individual to complete certain goals, remind them to take action, suggest actions to take, thank them for what they have done, provide information to them, and/or incorporate their texts and photos with additional information into documents that can, optionally, be printed.

### REFERENCE TO PENDING PRIOR PATENT APPLICATION

This patent application claims benefit of pending prior U.S. Provisional Patent Application Ser. No. 62/160,051, filed May 12, 2015 by myActions, LLC and Craig S. Young et al. for METHOD AND SYSTEM FOR THE IMPLEMENTATION OF CELL PHONE TEXTING TO BE USED WITH ENTERING DATA FOR SOCIAL NETWORKS (Attorney's Docket No. YOUNG-2 PROV), which patent application is hereby incorporated herein by reference.

### FIELD OF THE INVENTION

This invention relates to individuals and their behaviors or actions in general, and more particularly to methods and systems for allowing individuals to share their behaviors or actions with others. Among other things, this invention relates to methods and systems for the implementation of cell phone texting to be used with entering data for social networks.

### BACKGROUND OF THE INVENTION

We have discovered that it is possible to use a social network to track and improve an individual's behaviors including, but not limited to, environmental, social, personal, health, philanthropic and/or community behaviors. The goal is to make it as quick and easy as possible for the individual to input data about the actions or activities that they are engaging in, when and/or where they are engaging in those behaviors.

Our first attempt was to create a social network for tracking and improving an individual's behaviors, with the social network being implemented on the Internet as a website. See FIG. 1, which shows a laptop computer 5 being used to access the website. This approach works well, however, the individual must log in to the social network at their computer and enter the information about their behavior after they have engaged in the behavior. One drawback of this approach is that if the individual inputs data about their behavior from their computer, it is not clear if they are changing their behaviors in the community.

To address this issue, we developed a mobile website and software application for smart phones so individuals could input the information using the browser on their smart phone when and where they are taking action (e.g., engaging in a behavior). See FIG. 2, which shows a cell phone 10 being used to access the website. This is an improvement over using a computer to access a website, but has the shortfall that the individual must have a smart phone and Internet connectivity. Smart phones and their data plans can be expensive and not everyone wants, has, or can afford this technology.

While we were developing the aforementioned web and smart phone tools, we noted that many organizations are trying to track and improve people's behaviors in many different areas. By way of example but not limitation, zoos and aquariums play an important role in educating the public about the issues facing animals and our environment, and they look for ways to encourage better behaviors into the community. By way of further example but not limitation, companies are often looking for ways to improve their employee's behaviors in areas including, but not limited to, energy-saving, recycling, environmental, social, and/or health behaviors. By way of still further example but not limitation, healthcare organizations, in addition to what has been stated above, frequently look for ways to improve patient compliance. And schools play a vital role in educating youth and are constantly looking for ways to improve student actions. Still other organizations (e.g., non-profits, philanthropics, etc.) also seek to improve people's behaviors.

The limitations of requiring an individual to have a computer with Internet access, or a smart phone with an Internet connection, limits the ability of organizations to interconnect with individuals and promote desired behaviors within the community.

### SUMMARY OF THE INVENTION

While the limitations of requiring an individual to have a computer with Internet access, or a smart phone with an Internet connection, limits the ability of organizations to interconnect with individuals and promote desired behaviors within the community, we have observed that communication via two-way text messaging (sometimes hereinafter referred to as “texting”) is available virtually everywhere.

Therefore, in accordance with the present invention, texting is used to provide a novel method and system for individuals to quickly and easily share their behaviors, actions, photographs, videos, other data, and/or posts on, but not limited to, a social network, without needing to be logged into, or even having an account on, the social network (e.g., a social network website). The novel method and system of the present invention uses, but is not limited to, existing texting technology as a fast and easy way for the individual to send keywords and/or additional information to the social network regarding their behaviors. In order to facilitate its use with the present invention, the texting interface for the system has the ability to bi-directionally collect and send data from/to the texting device and has a bi-directional communication scheme to transfer the data from the texting system to the appropriate social network (e.g., a social network website). The texting interface presented to the individual is generally provided by a cell phone, although it could also be provided by other means (e.g., a text messaging-enabled tablet, a text messaging-enabled computer, etc.). The cell phone (i.e., the texting device) is able to provide a unique identifier (ID) such as, but not limited to, the phone number of the cell phone, which can optionally be linked to an account on the social network. The social network then processes the information provided to the social network via texting from the individual, optionally stores the information, and/or responds to the individual with feedback. Such feedback may be presented to the individual by the social network website texting back to the texting device, presenting the feedback on a separate display, displaying the feedback (or other information) on the social network website, and/or by other means. By way of example but not limitation, the content of the feedback can be designed to encourage the individual to complete certain goals, remind them to take action, suggest actions to take, thank them for what they have done, provide information to them, and/or incorporate their texts and photos with additional information into documents that can, optionally, be printed.

The present invention allows individuals to enter, and share, their behaviors quickly and remotely, using any cell phone (or other texting device) that has texting capabilities. The ability to use any cell phone with texting capabilities provides, but is not limited to, the following benefits:

A. Texting has broader coverage than Internet access on cell phones, from both a location and a device-capability point of view;

B. The phone number of the cell phone can provide a unique identifier (ID) for the texting device which provides a means for the social network website to store and locate data related to that particular device;

C. Texting provides an easy path to join, participate, and/or opt out of the social network;

D. Texting provides the ability to share behaviors, actions, photographs, videos, other data, and/or posts on a social network without needing to be logged in, have Internet access to, or even have an account on the social network;

E. Keywords within the text message can be used to communicate to the social network website how to process the given information;

F. Keywords within the text message may include information to identify the physical location where the individual is engaging in a particular behavior;

G. Keywords within the text message may include information to identify the organization that the action/data is associated with;

H. Texting is easy for organizations to integrate into their programs by the use of handouts, signs, and/or displays with, for example, a message such as “Text [a keyword and/or additional data] to [a text number or short code]” to create the action/post, e.g., “Text Recycle Can to 21212”;

I. The phone location, if permitted by the individual or carrier, can be used to associate the action to a physical location;

J. Until the phone number is associated with an account, the social network can limit the amount of data and/or the type of data that is displayed in any feedback sent back to the cell phone by the social network;

K. Previous actions/posts created by texting may be integrated into the individual's account when the account is associated with the cell phone number;

L. The content of the feedback can, optionally, encourage the individual to complete certain goals, remind them to take action, suggest actions to take, thank them for what they have done, provide information to them, and/or incorporate their texts and photos (with additional information) into documents that can, optionally, be printed; and

M. The social network can easily follow up with the individual by texting to their cell phone number.

For example, the use of texting allows zoos, schools, corporations, and other organizations to provide the means for people to enter their environmental/social/health/etc. actions, at little to no cost to them, further enhancing their behavior changes and bringing the message into the community. Informational signs, displays, handouts and/or other means can be used to explain what to do (i.e., how to enter behavior data into the system via texting). Furthermore, by virtue of being quick and easy, and by virtue of the fact that the individual does not need to login on a computer, data entry does not take time away from their productivity at work or cost them much time when they are otherwise busy or enjoying themselves.

Since texting is quiet, quick, and easy, it allows for data to be texted at places like schools, hospitals, theaters, churches, or any other places where other technologies may be considered disruptive.

Additionally, the present invention allows organizations to track their effect on modifying environmental/social behaviors outside of their organization, in the community and anywhere individuals use their cell phones around the country or the world.

In one form of the present invention, there is provided a system for communicating with a social network, the system comprising:

a bi-modal texting system;

a device having a unique identifier and configured to (i) send a text message with its unique identifier to the bi-modal texting system, and (ii) receive a text message having its unique identifier from the bi-modal texting system; and

an input/output interface configured to (i) receive a text message with its unique identifier from the bi-modal texting system and to transfer the data from that text message with its unique identifier to the social network, and (ii) receive a text message with a unique identifier from the social network and to transfer that text message with its unique identifier to the bi-modal texting system for delivery to a device having that unique identifier.

In another form of the present invention, there is provided a method for communicating with a social network, the method comprising:

providing a system comprising:
a bi-modal texting system;
a device having a unique identifier and configured to (i) send a text message with its unique identifier to the bi-modal texting system, and (ii) receive a text message having its unique identifier from the bi-modal texting system; and
an input/output interface configured to (i) receive a text message with its unique identifier from the bi-modal texting system and to transfer the data from that text messages with its unique identifier to the social network, and (ii) receive a text message with a unique identifier from the social network and to transfer that text message with their unique identifier to the bi-modal texting system for delivery to a device having that unique identifier; and

sending a text message from the device to the social network using the bi-modal texting system and the input/output interface.

In another form of the present invention, there is provided a method for participant engagement, the method comprising:

combining text messages with or without included photos with additional information and/or media to create a customized and personalized document to capture an experience.

In another form of the present invention, there is provided a system for communicating with a social network, the system comprising:

a texting system;

a device configured to send a text message to the texting system; and

an input/output interface configured to receive a text message from the texting system and to transfer the data from that text message to the social network.

In another form of the present invention, there is provided a method for communicating with a social network, the method comprising:

sending a text message with a unique identifier to an input interface of the social network;

extracting at least one keyword from the text message; and

transferring that keyword with the unique identifier to the social network.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing a laptop computer being used to access a social network via a website;

FIG. 2 is a schematic view showing a smart phone being used to access a social network via an app;

FIG. 2A is a schematic view showing a novel system for allowing individuals to use texting to communicate with a social network;

FIG. 3 is another schematic view showing a novel system for allowing individuals to use texting to communicate with a social network;

FIGS. 4-9 are schematic views showing various details of a novel system for allowing individuals to use texting to communicate with a social network;

FIGS. 10-15 show various ways in which feedback may be delivered to individuals by the social network;

FIGS. 16-19 are schematic views showing how an individual's texted messages and/or included photos can be incorporated into a document with additional information that the individual can view and, optionally, print; and

FIG. 20 is a schematic view showing an exemplary form of the present invention.

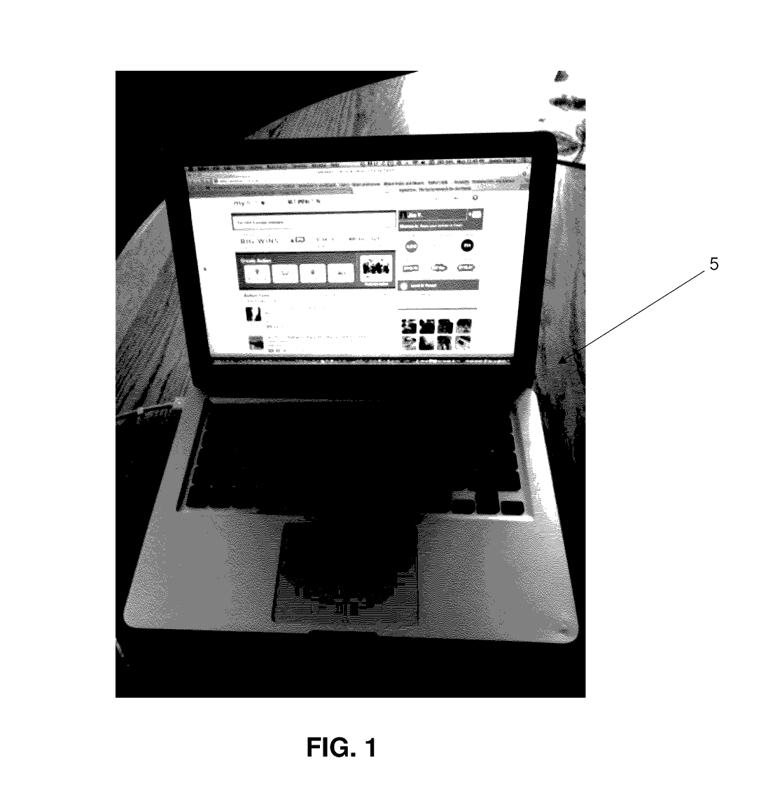

### DETAILED DESCRIPTION OF THE PREFERRED EMBODIMENTS

The present invention comprises a novel method and system for allowing individuals to quickly and easily share behaviors, actions, photographs, videos, other data, and/or posts on (but not limited to) a social network, without requiring the individual to be logged into, or even having an account on, the social network (e.g., a social network website). The novel system of the present invention comprises various components to allow the individual to use texting to enter data into a social network quickly and efficiently.

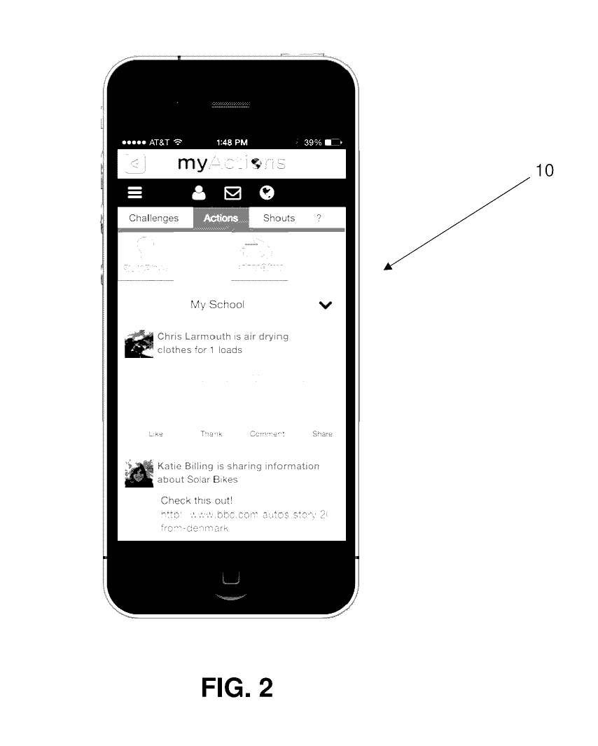

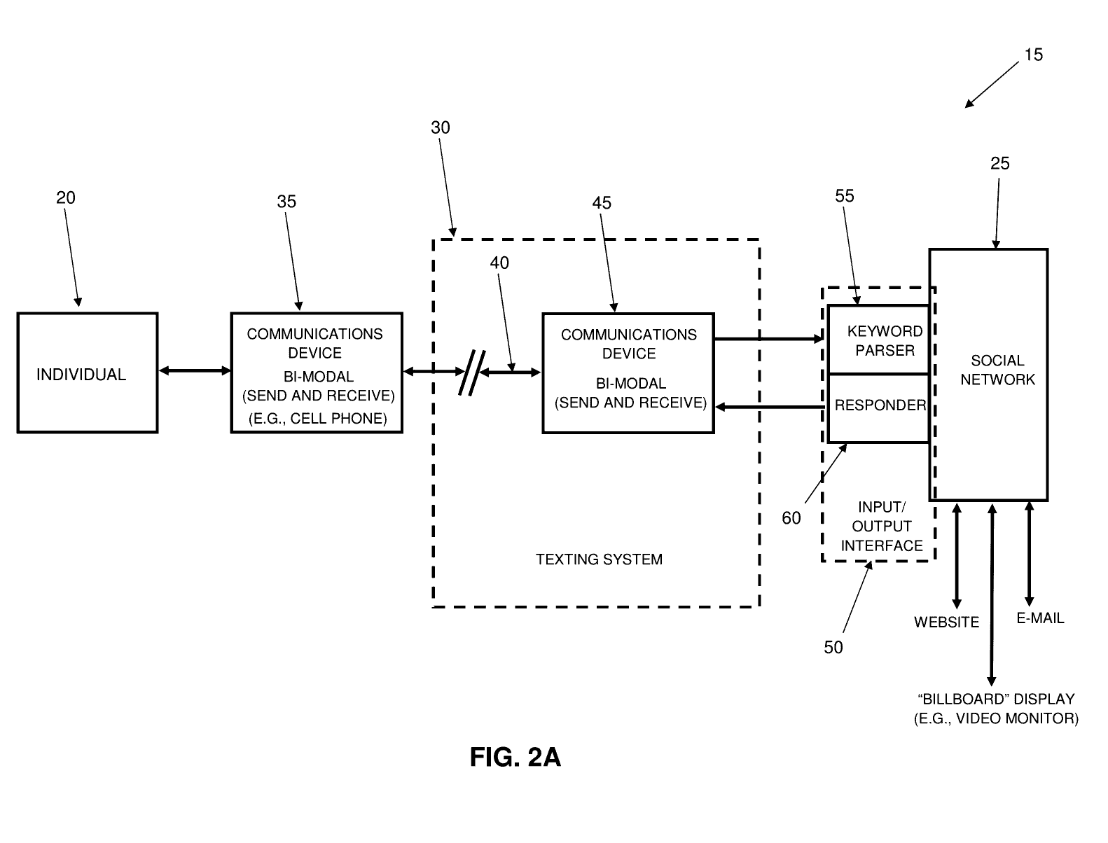

More particularly, the present invention comprises the provision and use of a novel method and system for an individual to interact with a social network, i.e., a texting system which is able to transmit text messages from one device to another, a texting device which enables an individual to send and receive text messages from the texting system, and an input/output interface for enabling the social network to interact with the texting system. In this way, an individual can use the texting device and the texting system to send text messages to the social network, and the social network can use its input/output interface and the texting system to send text messages to the texting device of the individual. See FIG. 2A, which shows a novel system 15 for enabling an individual 20 to interact with a social network 25. System 15 generally comprises a text messaging system 30 which is configured to receive text messages from a communications device 35 (e.g., an individual's cell phone) and send those text messages through a communications network 40 to another communications device 45. Communications device 45 in turn communicates with an input/output interface 50 which is provided for social network 25. Input/output interface 50 generally comprises a keyword parser 55 which parses data (preferably in the form of keywords, etc.) received from communications device 45 and passes that data to social network 25, and a responder unit 60 which receives messages from social network 25 and passes them to communications device 45 for delivery through communications network 40 to communications device 35 (e.g., an individual's cell phone) for viewing by individual 20. It will be appreciated that social network 25 typically comprises a web-based platform implemented on appropriate computer hardware and software, and input/output interface 50 (including both its keyword parser 55 and responder 60) typically comprises a functional module implemented in appropriate software.

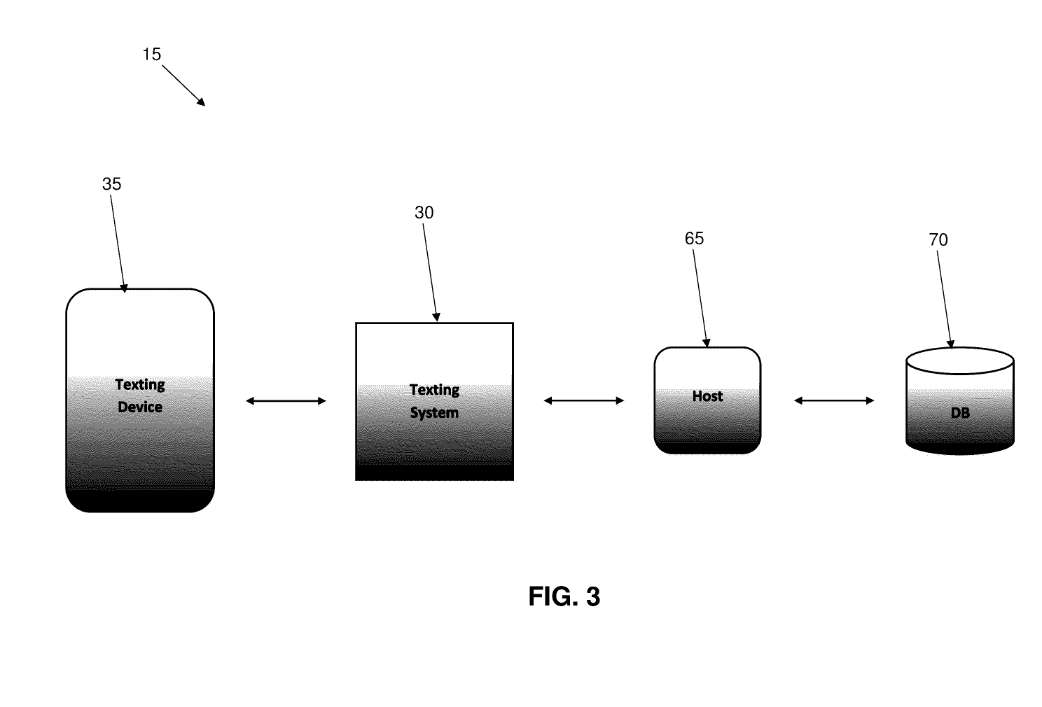

In one form of the invention, and looking now at FIG. 3, the overall system 15 can be considered to have four major components, i.e., a texting device 35, a texting system 30, a host 65 (which comprises social network 25 and input/output interface 50) and a database 70 (which may, for some purposes, be considered a subunit of social network 25). It will be appreciated that the overall system and its major components (i.e., texting device 35, texting system 30, host 65 and database 70) can have various implementations.

The implementation of the overall system and the major components includes, but is not limited to:

1. A texting device with texting capabilities having a unique ID;

2. The texting system has the ability to bi-directionally collect data from the texting device and send data to the texting device;

3. The texting system has a bi-directional communication scheme which can be used to transfer data from the texting system to the appropriate social network (e.g., a social network website);

4. The texting system includes a unique ID which can be derived from the cell phone number, provided by the serial number of the texting device, or be another unique ID;

5. The texting system permits the use of a keyword (or keywords) which can provide the context for the text message and are related to the behaviors and actions the individual wants to communicate to the social network (e.g., a social network website);

6. The social network then processes the information sent by an individual in a text message, optionally stores the information (e.g., in a database), and/or responds to the individual (e.g., via a text message);

7. The individual has the option of creating an account on the social network and, optionally, linking the account with the unique ID from the texting device;

8. Feedback from the social network (e.g., a social network website) can include a link to a website with information, optionally encrypted, in the URL used in creating or referencing an account related to this texting device;

9. Feedback may be presented by the social network (e.g., a social network website) by texting back to the texting device, presenting the response on separate displays, displaying the information on the website, or by other means;

10. Content of the feedback can (but is not limited to) encourage the individual to complete certain goals, remind the individual to take action, suggest actions for the individual to take, thank the individual for what they have done, and/or provide information to the individual;

11. The individual's engagement (e.g., with the social network) can be further enhanced by incorporating the individual's texted message(s) and/or included photo(s) into a document with additional information that the individual can view on the web (e.g., on a website), and which may be designed specifically to be printer friendly, and, optionally, printed; and

12. Another content possibility allows the individual to interactively create a diary of their actions on the social network (e.g., a social network website) using the content from their text messages and/or the photos they included with the text messages.

1. A Texting Device with Texting Capabilities Having a Unique ID.

The texting device can consist of any device capable of sending text messages to a texting system utilizing a unique ID. By way of example but not limitation, this is possible with cell phones. Currently, almost all cell phones include the ability to send and receive text messages. This allows the technology to be accessed by anyone who has a cell phone with a texting plan.

2. The Texting System has the Ability to Bi-Directionally Collect Data from the Texting Device and Send Data to the Texting Device.

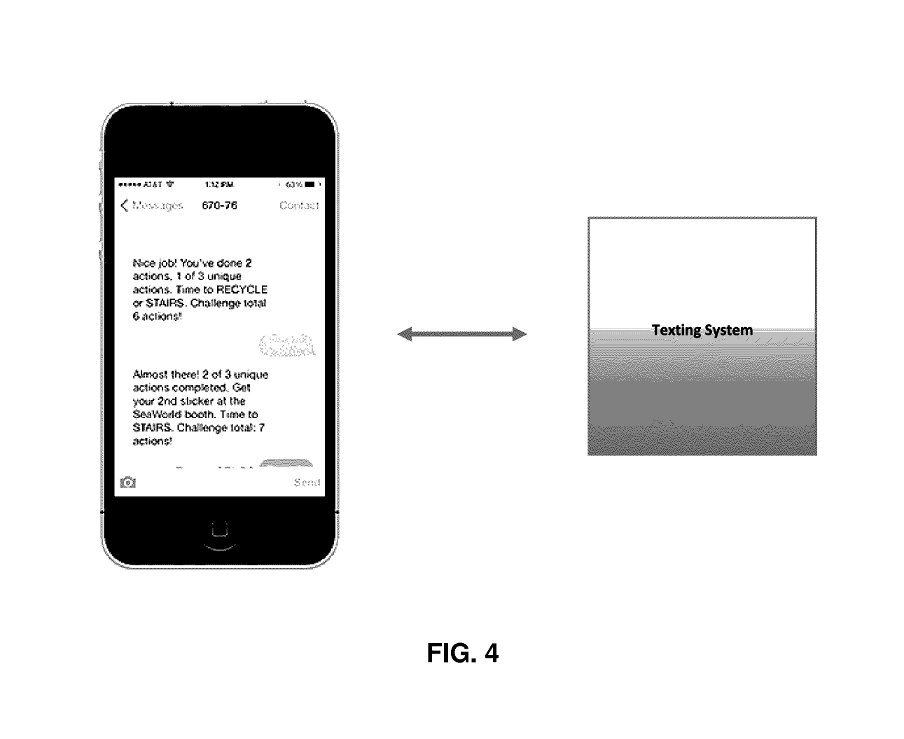

The texting system can comprise any technology that supports texting from a device having a unique ID to a texting system. The texting system can be one of the existing texting services or a newly developed texting system. The texting system has the ability to provide bi-directional communication to the texting device. See FIG. 4.

3. The Texting System has a Bi-Directional Communication Scheme which can be Used to Transfer Data from the Texting System to the Appropriate Social Network/Website (e.g., a Social Network Website).

The texting system can connect to the host or hosts in a variety of ways including, but not limited to, using the Internet or other network via wired local area network, Wi-Fi or other wireless communications.

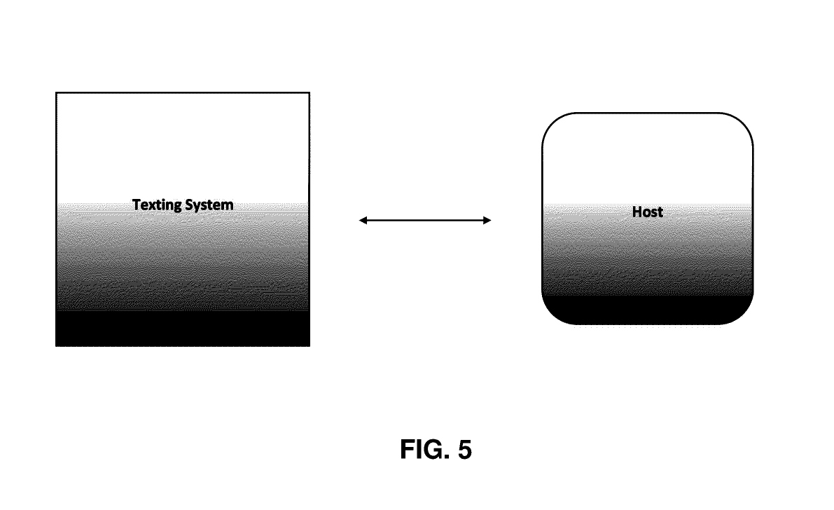

One scheme is for the texting system to send the information to a single host. See FIG. 5.

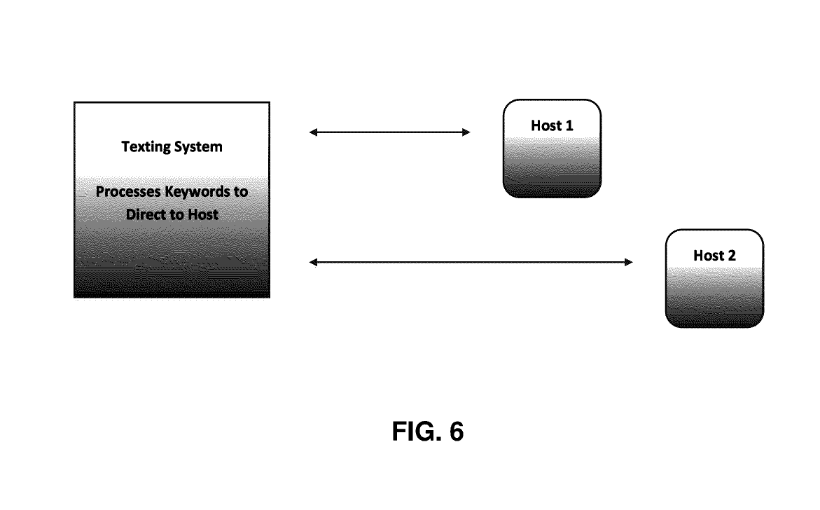

Another scheme is for the texting system to decide which host to send the information to, e.g., as determined by the keyword(s) used in the text message. See FIG. 6.

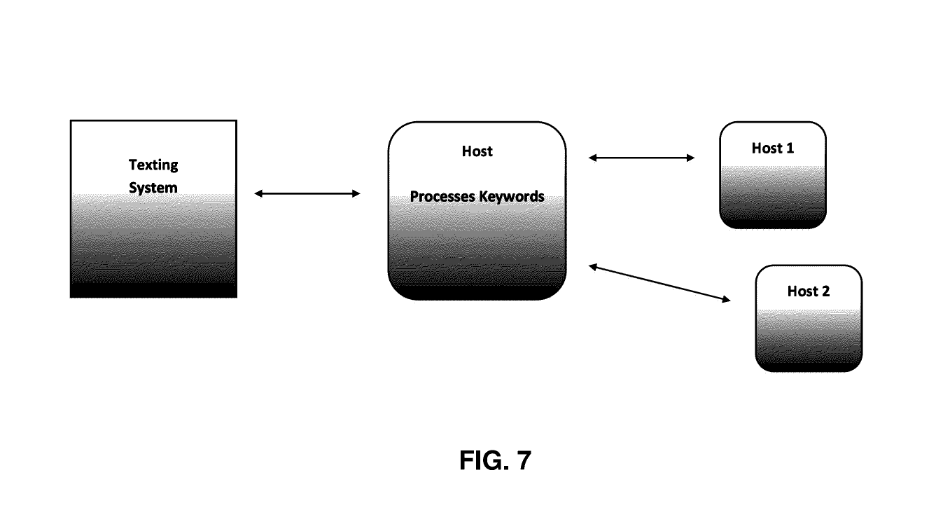

Another scheme would be to send all information to one host and have that host process the keywords in order to determine what host to send the information to. See FIG. 7.

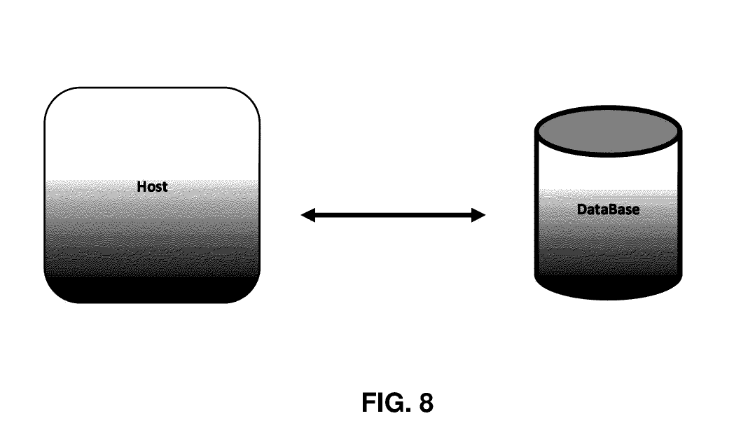

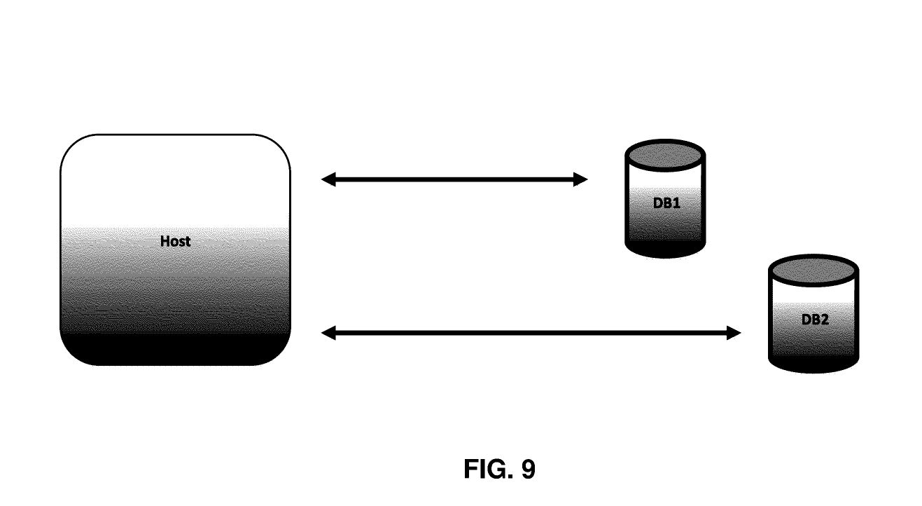

The host system can be set up as one large database or several different databases. Several companies or organizations may want to have their own database on a separate host. See FIGS. 8 and 9.

4. The Texting System Includes a Unique ID which can be Derived from the Cell Phone Number, Provided by the Serial Number of the Texting Device, or be Another Unique ID.

A unique ID is required from the device so the social network can identify the source that the action (e.g., a text message) came from. The simplest, and most prevalent, unique ID is the phone number associated with the texting device (e.g., the phone number associated with the cell phone used for texting). By including the country code of the phone number, the phone number becomes a worldwide unique ID. Another possibility would be to use the serial number associated with the texting device, however, the texting device would somehow need to know to include that information in texts that are sent. Using a system other than current texting technologies, the newly created texting device could include a unique ID associated specifically with that texting device.

5. The Texting System Permits the Use of a Keyword (or Keywords) which can Provide the Context for the Text Message and are Related to the Behaviors and Actions the Individual Wants to Communicate to the Social Network (e.g., a Social Network Website).

By way of example but not limitation, the data sent by an individual in a text message can include keyword(s) and, optionally, additional information about the behavior including, but not limited to text, values (e.g., numbers or quantities), pictures, comments, etc. In one form of the present invention, one or more keywords are required for the social network to be able to process the incoming data from a text message sent by an individual.

By way of example but not limitation, exemplary single keywords include “Recycle”, “Reuse”, “Reduce”, “Walking”, “Biking”, “Carpooling”, “Planting”, “Composting”, “Volunteering”, etc. This may be enough information to clearly communicate the action that the individual is engaging in to the social network.

Sometimes a second keyword may be required in addition to a first keyword in order to specify an action that the individual is engaging in, or be used for further clarification. By way of example but not limitation, some exemplary second keywords include “Recycle Aluminum”, “Reduce Paper”, or “Donate Clothes”.

A keyword may be used by an individual in a text message in order to identify an organization such as a school, business or other organization. This can be a commonly defined acronym for the organization, a newly defined acronym, or the organization name without spaces. For example, Ohio State University may use the acronym “OSU”.

In order to include keywords in a sentence that is being texted, the user may use a unique symbol such as, but not limited to, a pound (hashtag) symbol # to indicate the presence of a keyword. For example, the text message could be “I am #recycling #paper at #OSU” where “recycling”, “paper” and “OSU” are the keywords. In this case the non-keywords may or may not be ignored by the social network receiving the text message.

Acronyms may also be used as keywords so as to reduce the number of keystrokes the individual needs to make for a particular text message. By way of example but not limitation, one such keystroke may be “TOL” which could stand for “Turn Off Lights”.

The keyword can, optionally, be followed by a number to indicate a quantity, e.g., Recycle Can 5.

The keyword can, optionally, be followed by a number to indicate a quantity, and can also include a unit, e.g., “Carpool 5 Miles”, “Carpool 5 M”, or “TOL 5 H”.

The value for the action taken by the individual may be a text string, in which case it may need a delimiter such as, but not limited to, a single quote or some other means. By way of example but not limitation, for the action “Going to the Zoo in Cincinnati” the text message may read “GTZ ‘Cincinnati’”. By way of further example but not limitation, for the action “Make Something From Reusable materials”, the text message may read “MSR ‘used bottles, cans and boxes’”.

Keywords may also include an identification scheme in order to efficiently identify things such as, but not limited to, the initials of a company, a code to indicate a particular location, a school ID, an event ID, etc. By way of example but not limitation “CZ1” could mean “Cincinnati Zoo location 1”.

Additional information can also be texted such as a comment defined by a delimiter such as (but not limited to) quotes or a “/” at the end of the action. By way of example but not limitation, the text message may read “Carpool 5 Miles “Went to the show with my friends”” or “Carpool 5 Miles/Went to the show with my friends”.

Photographs, videos, and/or other media may optionally be included in the text message as additional information relating to the action.

The keyword can also indicate that a particular text message is just a social post, for example, “Post ‘I am having fun at the beach today’” may not be a specific action per se in the system, but the message can be posted on the feed (e.g., on the social network) for that texting device.

6. The Social Network then Processes the Information Sent by an Individual in a Text Message, Optionally Stores the Information (e.g., in a Database), and/or Responds to the Individual (e.g., Via a Text Message).

Using the previously described keywords as an input language, the social network can process the information (i.e., the texted data) and create an action or a post for the texting device. In the event the information cannot be processed, e.g., due to mis-typing or incorrect syntax, the social network may need to ask the individual for clarification or verify with the individual what it has determined is most likely the action the individual intended to send to the social network.

7. The Individual has the Option of Creating an Account on the Social Network and, Optionally, Linking the Account with the Unique ID from the Texting Device.

At some point the individual may decide to create an account on the social network, then the individual can use the social network's user interface for creating actions via the Internet.

Optionally the individual can link the texting device's unique ID with their account. Once linked, the account can optionally access all of the actions previously input from the individual's texting device. Furthermore, new actions can be created in an individual's account, e.g., either by texting or by using the Internet.

8. Feedback from the Social Network (e.g., a Social Network Website) can Include a Link to a Website with Information, Optionally Encrypted, in the URL Used in Creating or Referencing an Account Related to this Texting Device.

For example the reply text may say “You can do more actions at www.mywebsite.org?info1=abc&info2=xvz”, where “abc” and “xyz” are optionally encrypted information to help connect (i.e., link) a particular texting device to a particular website account (e.g., an account on the social network).

9. Feedback May be Presented by the Social Network (e.g., a Social Network Website) by Texting Back to the Texting Device, Presenting the Response on Separate Displays, Displaying the Information on a Website, or by Other Means.

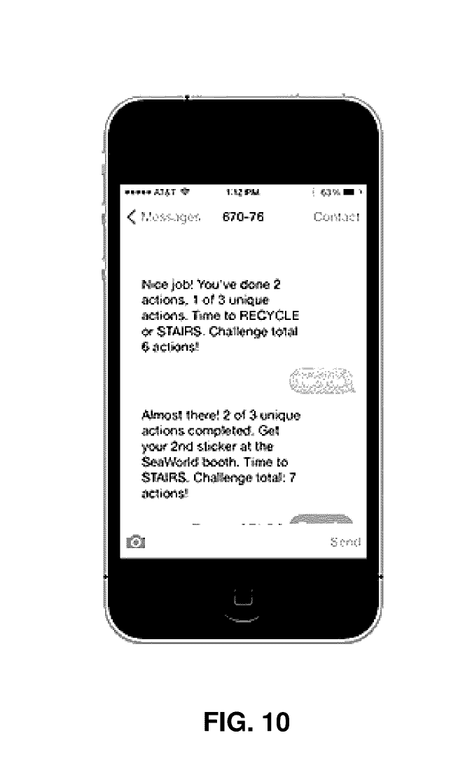

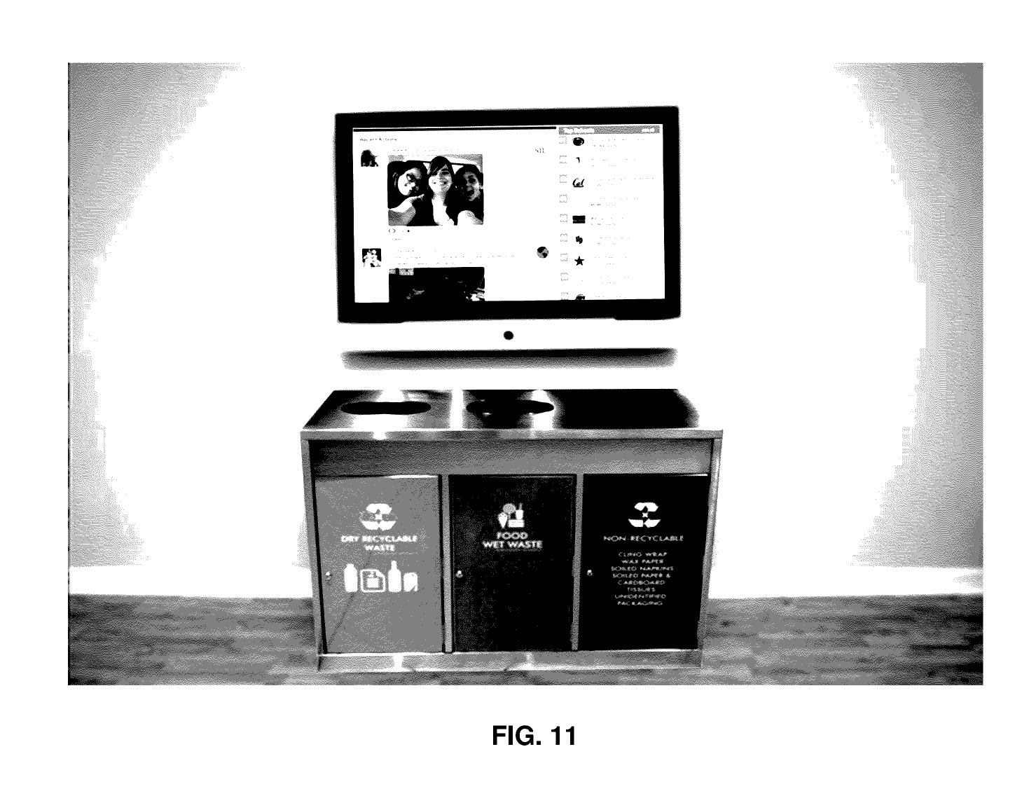

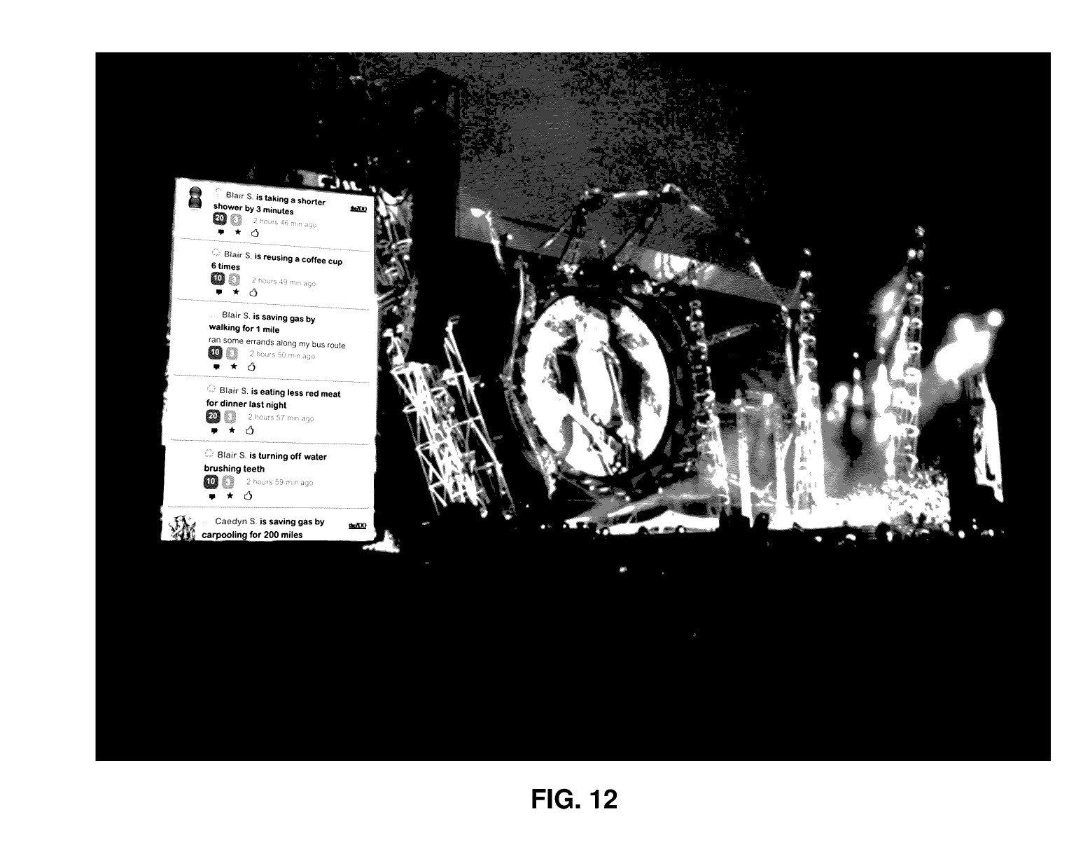

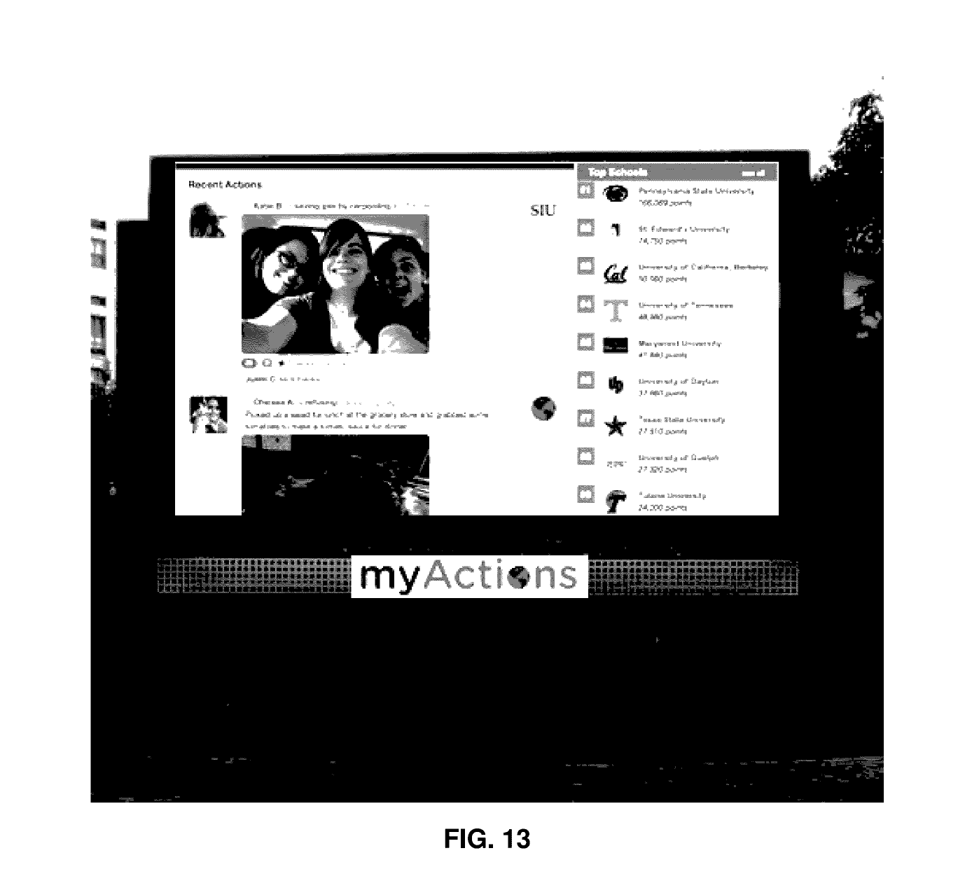

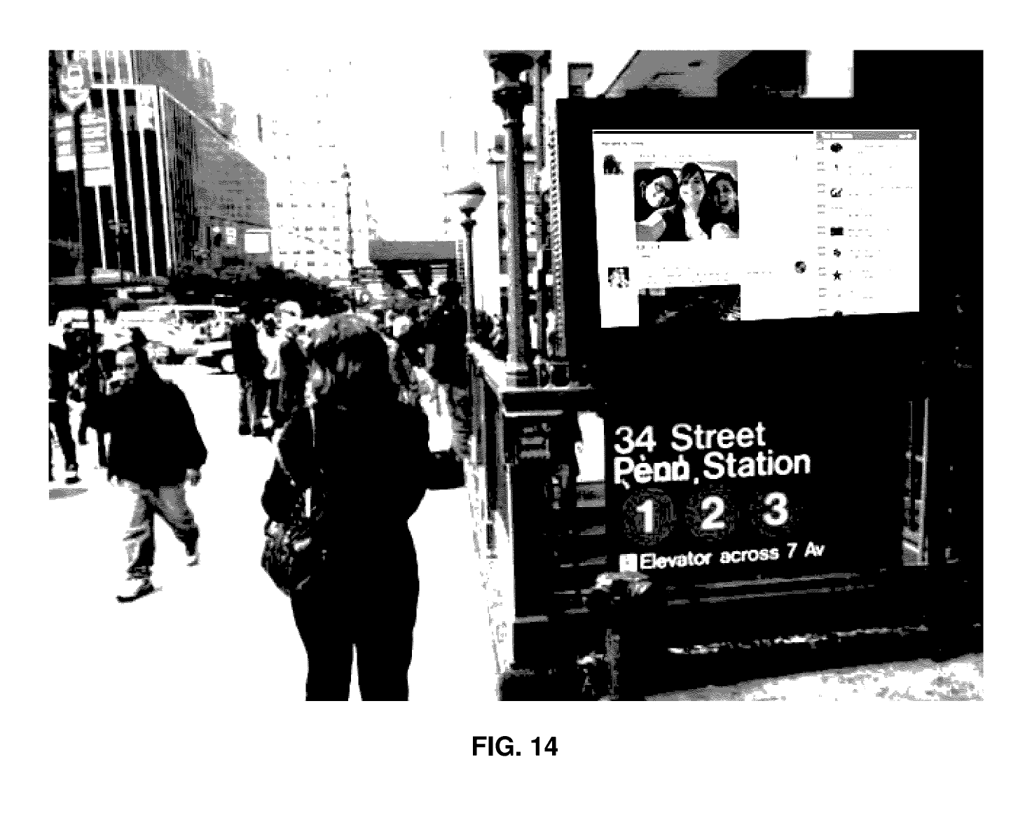

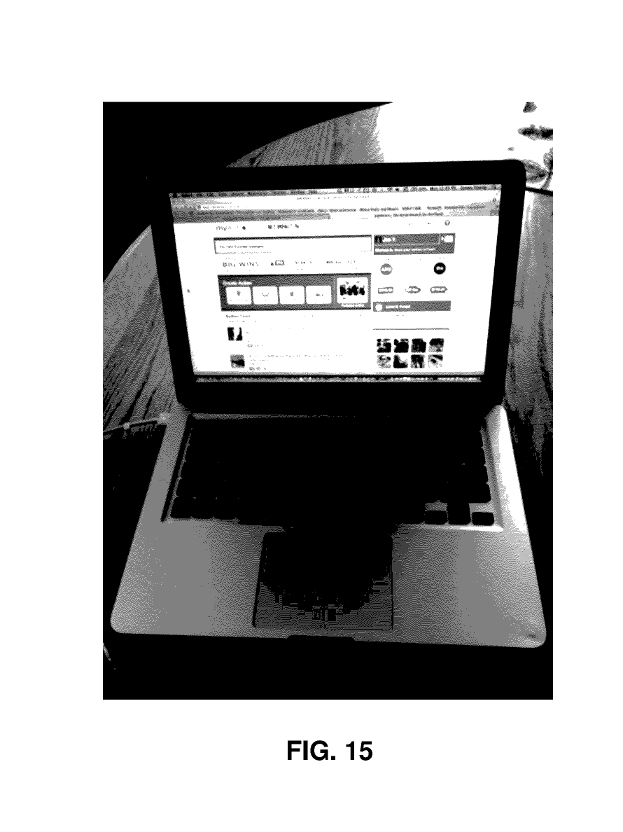

Feedback to the individual can happen in a variety of ways including, but not limited to, the following:
A. Feedback can be provided to the individual by the social network sending a text message to the texting system. The texting system would then send a text message to the individual's texting device. See FIG. 10.
B. Feedback can be provided to the individual at the time they send their keyword to the social network (e.g., via a text message), at a later time, or when a certain goal has been achieved by the individual.
C. A display device can be located at a particular location encouraging an individual to take a particular action. By way of example but not limitation, such particular location may include a recycle bin, a water fountain, a volunteer organization, a store, etc. When the individual texts the keyword(s) to the social network, they may see the results on the display device at the particular location in real time, or when the display updates. See FIG. 11.
D. Feedback can be displayed on a screen at an event in order to display the actions taking place at the event or overall actions being entered by a plurality of individuals. See FIG. 12.
E. Feedback can be displayed on strategically-placed electronic billboards. The placement of these electronic billboards serves to reinforce (i.e., promote) certain behaviors, as well as to get others interested in participating and improving their behaviors. See FIGS. 13 and 14.
F. Feedback can be provided to the individual when they log into their account (e.g., on the social network) on the host system. See FIG. 15.
G. Feedback can be sent to the individual via E-mail if they selected E-mail notification as an option.
H. Feedback can be sent to other devices including, but not limited to, phones, watches and/or other wearable technologies.

10. Content of the Feedback can (but is not Limited to) Encourage the Individual to Complete Certain Goals, Remind the Individual to Take Action, Suggest Actions for the Individual to Take, Thank the Individual for What they have Done, and/or Provide Information to the Individual.

The content of the feedback can encourage an individual to complete a particular goal, e.g., a set of actions defined in an action plan.

The content of the feedback can suggest actions for an individual to take based on that particular individual's interests, or the content can encourage an individual to take new actions.

The content of the feedback can suggest places to look for actions, e.g., creating a scavenger hunt for creating sustainable, caring, and healthy actions.

The content of the feedback can include a variety of information including, but not limited to, information about what the individual did, the impact of the individual's action for a particular organization, the impact of an individual's action for the environment, the impact of an individual's action for the community, the total impact of everyone's actions, etc.

Other content possibilities include using the keyword to retrieve information about a particular topic. This information can increase in depth if the user repeatedly texts the keyword.

11. The Individual's Engagement (e.g., with the Social Network) can be Further Enhanced by Incorporating the Individual's Texted Message(s) and/or Included Photo(s) into a Document with Additional Information that the Individual can View on the Web (e.g., on a Website), and which May be Designed Specifically to be Printer Friendly, and, Optionally, Printed.

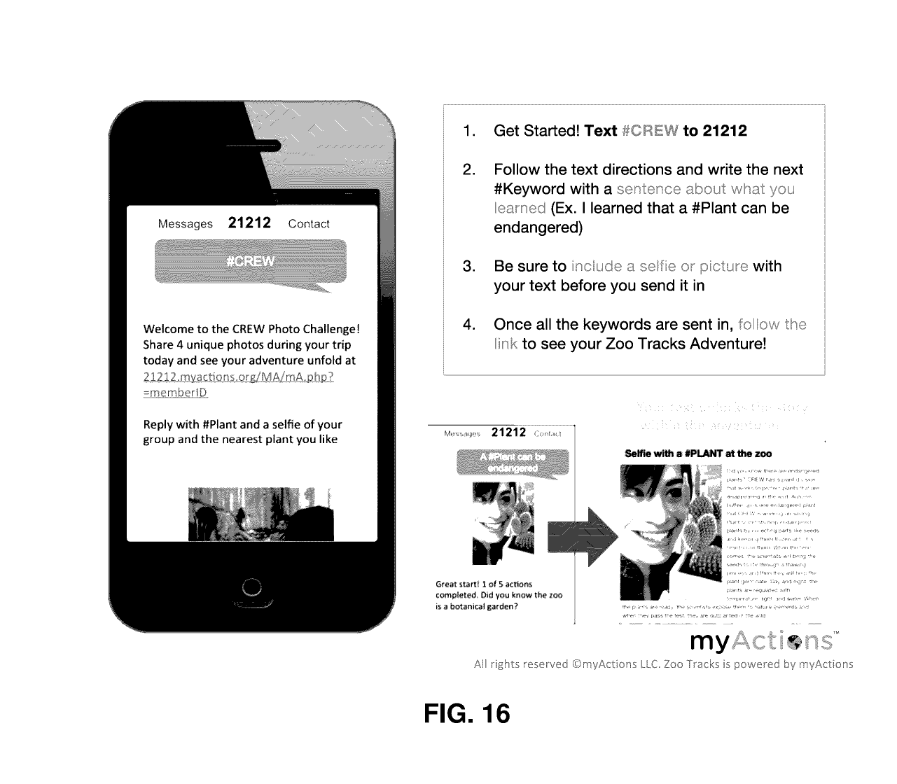

The feedback from the system may (or may not) provide a link to a website (e.g., an online document) that uses the individual's texted information. See FIG. 16. It should be appreciated that the individual may complete all the actions while remaining within the texting application (app) on the cell phone and choose to see their online document on their cell phone, or on a computer after they have completed the actions. The final message from the system may or may not include a link to view the individual's online (e.g., website) document.

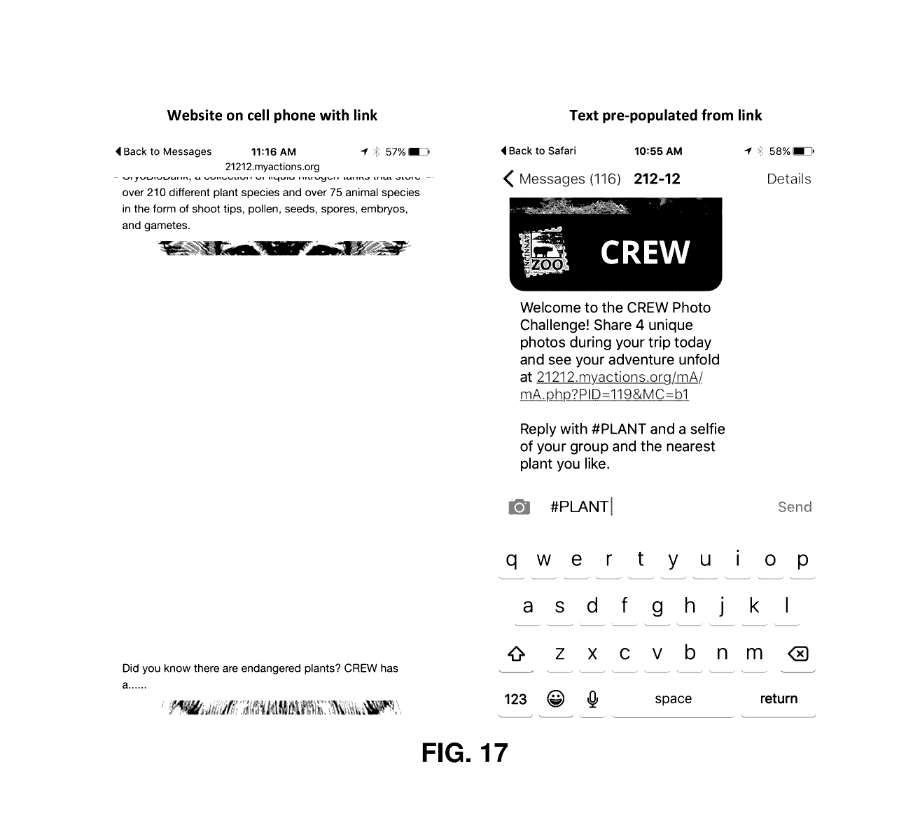

The website (e.g., the social network) can, optionally, “sense” (i.e., determine) if the individual is on a cell phone and can provide a link in the online document for the individual's next action or available actions. See FIG. 17 which shows a website on a cell phone with a link. This link can be used to take the individual directly back to texting, and may (or may not) pre-populate the text field with a keyword or a message. See FIG. 17 which also shows a text message pre-populated from link. The website can, optionally, “sense” (i.e., determine) if the participant is on a computer or tablet, and may not provide the link in such a situation, since texting may not be available on those types of devices.

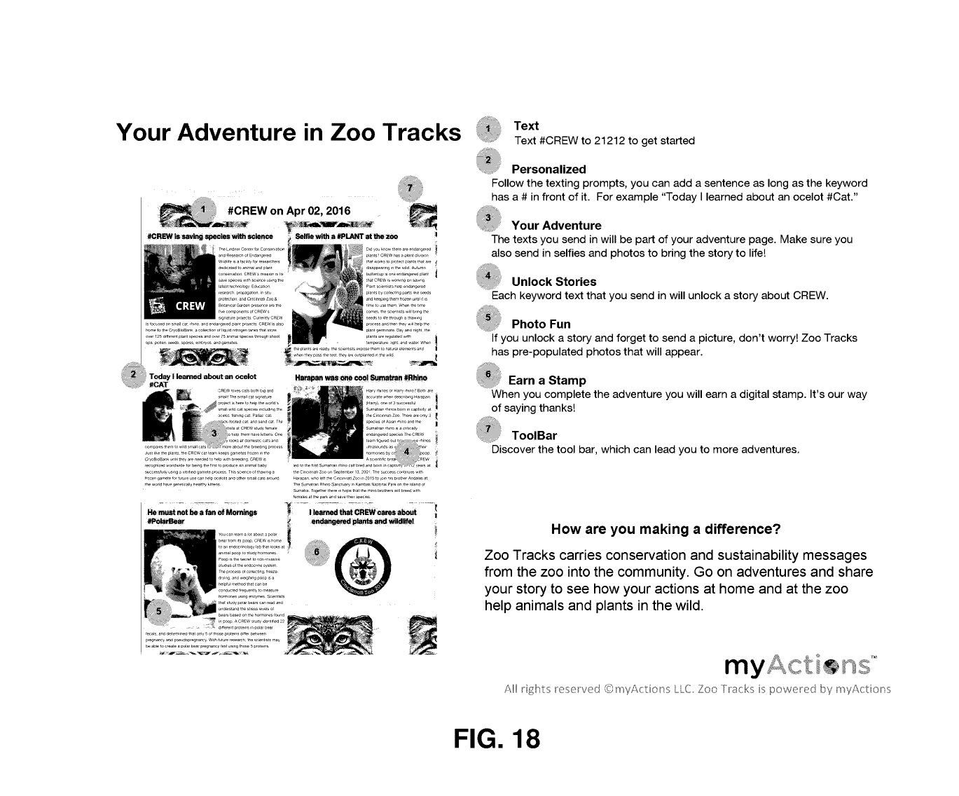

The additional information on the website can include any type of content that can be shown on a web page including, but not limited to, paragraph text, bulleted lists, links, backgrounds, photos, videos, audio links, quizzes, surveys, etc. See FIG. 18. In a preferred form of the present invention, the website is specifically designed to be print-friendly.

If the individual did not include a photo in a text to the social network (i.e., the website), the website may or may not use a default photo in the document that is generated. See FIG. 18.

Furthermore the same texting program can include custom information in the website document for different organizations, i.e., custom information that is tailored to the message that organization wants to share with the individual. This custom information is determined by the organization that the individual joined in their texting experience. By way of example but not limitation, the same zoo texting program could provide different information on the website document (layout, information, colors, etc) if the individual was a member of the Cincinnati Zoo than would be provided if the individual was a member of the San Diego Zoo.

By integrating the website document with the texting experience, it is possible to provide a menu link that allows the participant to support or make a donation to an organization related to the information in the document. See FIG. 18 (Toolbar example shows “Support CREW”).

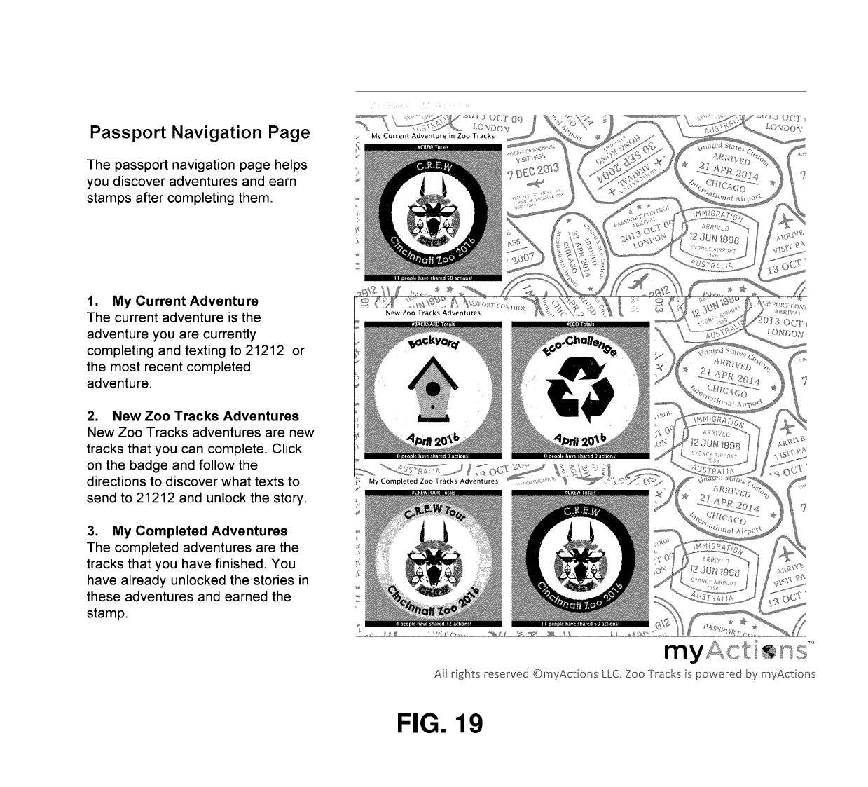

An important feature of the present invention is the ability to have a menu in the toolbar on the online document (i.e., the webpage) that links to more programs that an individual can do and what they have accomplished. See, for example, FIG. 18 (Toolbar example shows “More Stories”). By way of example but not limitation, this webpage can show an individual the current program they are on (i.e., currently engaged in), new programs that the individual can join, and programs that the individual has completed. See FIG. 19, where the programs are labelled “Adventures”. These can be programs that the individual can participate in at a particular venue or in the community. This provides the venue with the ability to verify that participation in the program at the venue can lead to participation in the community.

Participation in these texting programs also provides the ability for further outreach by the system, e.g., by sending a follow-up text message to an individual encouraging the individual to join a new program or to take another action related to the program.

This two-way interaction with the social network (i.e., the website) through texting allows the individual to have a deeper experience, i.e., by allowing the individual to provide and receive more information to/from the website than is possible with just two-way texting of responses (i.e., by incorporating the individual's texted messages and/or photos into a document having greater content than just the individual's own messages).

12. Another Content Possibility Allows the Individual to Interactively Create a Diary of their Actions on the Social Network (e.g., a Social Network Website) Using the Content from their Text Messages and/or the Photos they Included with the Text Messages.

In this form of the present invention, the text messages sent by the individual and/or any included photos, would be available for the individual to place on a page to create their own layout for printing or for including in a book layout for printing. The individual could also add text or other scrapbooking artwork.

### One Exemplary Embodiment of the Present Invention

In one preferred embodiment of the present invention (but by no means the only way to implement this invention), current texting technology is used to connect an individual to a social network. Most cell phones include the ability to text messages and to receive text messages. This makes the present invention accessible to anyone with a cell phone and a texting plan. There are numerous texting services which possess the ability to communicate with the Internet (i.e., with a website), thereby solving the infrastructure required for this invention to be implemented.

Although many social networks are also available, the present invention requires specific computer software to be developed to process the information, create the actions/posts in the social networks database, and display the feedback to the texting device as well as display the feedback on the social network system. Therefore we have developed a social network with these capabilities.

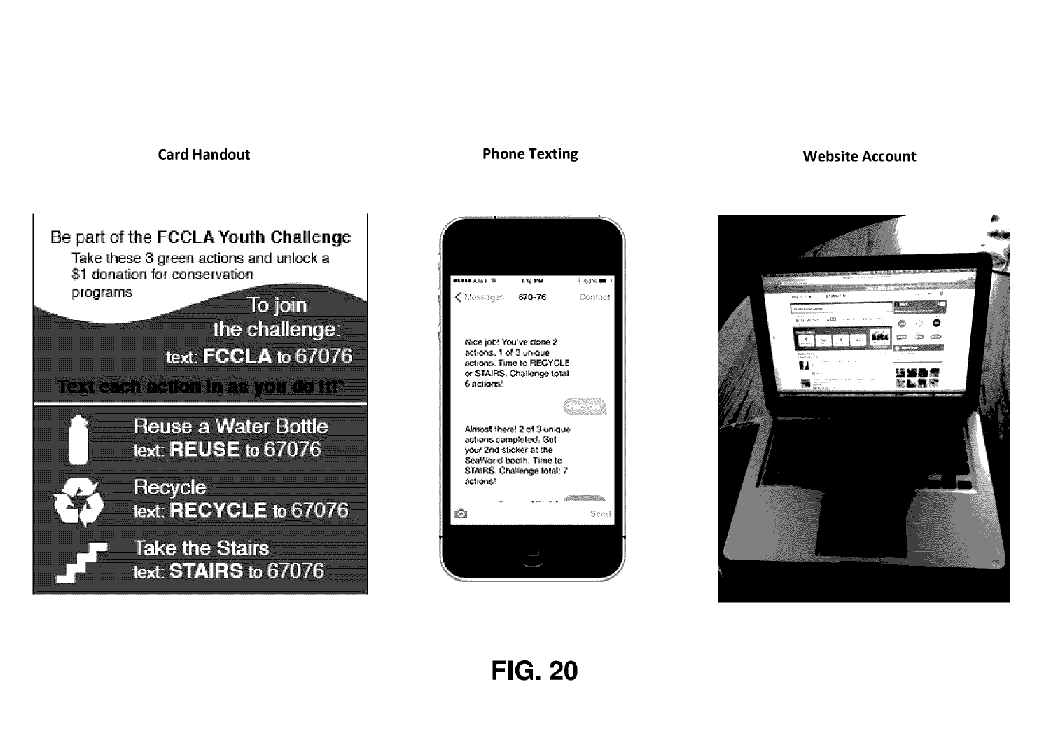

As stated previously, the present invention makes it very easy for organizations to use texting to provide a way for people to enter their environmental/social/health/etc. actions into a social network, at little to no cost to the individual using the system. Informational signs, displays, handouts and/or other means can be used to explain what to do. By way of example but not limitation, a card the size of a credit card can be handed out that explains how to interact with the social network. See, for example, the exemplary “Card Handout” shown in FIG. 20. This card has instructions for the individual on what to do (i.e., what action to perform), why to do it (i.e., why to perform the action), and what the organization is (i.e., the name of the organization, the goals of the organization, etc.). The individual can then text their actions as is shown in the phone image (see, for example, FIG. 20, “Phone Texting”), and the user will receive feedback (e.g., in the form of a text message) on their cell phone. The data (e.g., the data texted by an individual to the social network, the data texted by the social network to the individual, etc.) can be stored on a social network, or in other database(s), and the individual can have the option to create an account to view the data or to not create an account and just use texting. Once the account is created the individual has the option to create actions by texting or by using the website. See FIG. 20 “Website Account”.

### Other Uses for the Present Invention

Other exemplary uses for this technology include, but are not limited to, the following:

A. Medical Compliance

It is known that one of the most significant issues in healthcare is patient compliance in taking prescribed medicine or following prescribed rehabilitation procedures (e.g., exercise, breathing, etc). The present invention can be used as a tool for enhancing medical compliance. More particularly, keywords can be used to indicate an action a patient does and/or the medicine the patient took. The keywords can be acronyms so the individual (i.e., the patient) does not need to text long names. The individual (i.e., the patient) can set up an account (e.g., with their healthcare provider) and the medicine or rehabilitation schedules can be input either by the individual or by the hospital/doctor's office. The individual (i.e., the patient) can then simply send a text message to the social network (i.e., to the healthcare provider) when they take a pill, do exercises, or follow any other prescribed procedure. By way of example but not limitation, an individual (i.e., a patient) could text “Took P1” to the social network (i.e., to the healthcare provider) to indicate that they had taken their first pill. If the pills are time-sensitive, the social network (i.e., the healthcare provider) could send a text message to the individual (i.e., the patient) reminding them to take the medication. Other procedures can also be linked with text keywords and can text follow-up messages as needed to increase patient compliance. The data sent to the social network (i.e., the healthcare provider) can then be used to review patient compliance and patient outcomes.

B. Business Information Input

The present invention can be used by a business for input of data such as, but not limited to, sales order input, customer data, follow up with a customer, business leads, and so on. The text message has a time stamp that can be used to determine when the data was input. Therefore it can be determined how much time elapsed between data inputs. This information can be used to determine things like, but not limited to, travel time, how long it took to make a sale, etc.

C. Point of Sales Merchandising

Point of sales merchandising could use the present invention in order to allow a customer (i.e., an individual) to text a keyword to a phone number, or to text a short code to a phone number, in order to purchase an item. If the individual has an account with the business, the cost of an item purchased can be put on their account and a confirmation number can be provided in order for the individual to pick up the item. If the individual does not have an account with the business, they could be prompted to pay for the item using other means, such as, for example, a credit card, debit card, etc., or the item could be put on hold and the individual could pay for the item when they pick it up. This could be used for a variety of industries including, but not limited to, POS merchandising, ticket sales, television marketing (including but not limited to programs like QVC network), radio marketing, etc.

### Other Means for Inputting Data

Other means for inputting data, besides texting, include but are not limited to appending data to a URL, computer programs or smart phone applications. Creating actions by appending data to the URL, e.g., “www.websitename.com/actions.php?ACTION=to1%205%20h” or by various other forms of appending data to the URL would allow the individual to create an action without needing to be logged in to the host system. Computer applications may provide a user-friendly interface for creating the URL text. Smart phone applications may provide a user-friendly interface for sending the text information to the texting system.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A system for communicating with a social network, the system comprising:
a bi-modal texting system;
a device having a unique identifier and configured to (i) send a text message with its unique identifier to the bi-modal texting system, and (ii) receive a text message having its unique identifier from the bi-modal texting system; and
an input/output interface configured to (i) receive a text message with its unique identifier from the bi-modal texting system and to transfer the data from that text message with its unique identifier to the social network, and (ii) receive a text message with a unique identifier from the social network and to transfer that text message with its unique identifier to the bi-modal texting system for delivery to a device having that unique identifier.

2. A system according to claim 1 wherein the texting system comprises a cellular telephone system and the device comprises a cellular telephone, and further wherein the unique identifier comprises the telephone number for the cellular telephone.

3. A system according to claim 2 wherein the cellular telephone comprises a smart phone.

4. A system according to claim 1 wherein the device comprises a text messaging-enabled device selected from the group consisting of a tablet computer, a laptop computer, and a desktop computer.

5. A system according to claim 1 wherein the input/output device is configured to extract at least one keyword from a text message and transfer that keyword to the social network with the unique identifier for the device which originated the text message.

6. A system according to claim 1 wherein the text message comprises at least one from the group consisting of text, photographs, videos, other data, and/or posts.

7. A system according to claim 1 wherein the social network is configured to track and improve an individual's behaviors.

8. A system according to claim 7 wherein the behaviors are selected from the group consisting of environmental, social, personal, health, philanthropic and community behaviors.

9. A system according to claim 7 wherein the text message comprises data concerning one from the group consisting of behaviors and actions.

10. A system according to claim 1 wherein the text message sent to the individual by the social network is configured to effect at least one from the group consisting of encourage the individual to complete certain goals, remind the individual to take action, suggest actions for the individual to take, thank the individual for what they have done, provide information to the individual, and/or incorporate the individual's texts and photos with additional information.

11. A method for communicating with a social network, the method comprising:
providing a system comprising:
a bi-modal texting system;
a device having a unique identifier and configured to (i) send a text message with its unique identifier to the bi-modal texting system, and (ii) receive a text message having its unique identifier from the bi-modal texting system; and
an input/output interface configured to (i) receive a text message with its unique identifier from the bi-modal texting system and to transfer the data from that text message with its unique identifier to the social network, and (ii) receive a text message with a unique identifier from the social network and to transfer that text message with its unique identifier to the bi-modal texting system for delivery to a device having that unique identifier; and
sending a text message from the device to the social network using the bi-modal texting system and the input/output interface.

12. A method according to claim 11 further comprising sending a text message from the social network to the device using the bi-modal texting system and the input/output interface.

13. A method according to claim 11 wherein the texting system comprises a cellular telephone system and the device comprises a cellular telephone, and further wherein the unique identifier comprises the telephone number for the cellular telephone.

14. A method according to claim 13 wherein the cellular telephone comprises a smart phone.

15. A method according to claim 11 wherein the device comprises a text messaging-enabled device selected from the group consisting of a tablet computer, a laptop computer, and a desktop computer.

16. A method according to claim 11 wherein the input/output device is configured to extract at least one keyword from a text message and transfer that keyword to the social network with the unique identifier for the device which originated the text message.

17. A method according to claim 11 wherein the text message comprises at least one from the group consisting of text, photographs, videos, other data, and/or posts.

18. A method according to claim 11 wherein the social network is configured to track and improve an individual's behaviors.

19. A method according to claim 18 wherein the behaviors are selected from the group consisting of environmental, social, personal, health, philanthropic and community behaviors.

20. A method according to claim 18 wherein the text message comprises data concerning one from the group consisting of behaviors and actions.

21. A method according to claim 11 wherein the text message sent to the individual by the social network is configured to effect at least one from the group consisting of encourage the individual to complete certain goals, remind the individual to take action, suggest actions for the individual to take, thank the individual for what they have done, provide information to the individual, and/or incorporate the individual's texts and photos with additional information.

22. A method for participant engagement, the method comprising:
combining text messages with or without included photos with additional information and/or media to create a customized and personalized document to capture an experience.

23. A method according to claim 22 wherein the customized and personalized document is printed.

24. A method according to claim 22 wherein the text messages originate from a single individual.

25. A method according to claim 22 wherein the text messages originate from a plurality of individuals.

26. A system for communicating with a social network, the system comprising:
a texting system;
a device configured to send a text message to the texting system; and
an input/output interface configured to receive a text message from the texting system and to transfer the data from that text message to the social network.

27. A method for communicating with a social network, the method comprising:
sending a text message with a unique identifier to an input interface of the social network;
extracting at least one keyword from the text message; and
transferring that keyword with the unique identifier to the social network.
